(19) United States
(12) Patent Application Publication
(10) Pub. No.: US 2006/0245028 A1
(43) Pub. Date: Nov. 2, 2006

(54) Light modulator device

(76) Inventors: Sriram Ramamoorthi, Corvallis, OR (US); Alexander Govyadinov, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/106,755

(22) Filed: Apr. 15, 2005

(51) Int. Cl. G02B 26/00

(52) U.S. Cl. 359/290

(57) ABSTRACT

A light modulator device includes a first leaf having a reflective surface formed thereon, a second leaf spaced apart from the first leaf, and a hinge, coupling the first leaf to the second leaf, the first leaf and second leaf being configured to have like charges selectively thereon to control a relative separation of said first leaf and said second leaf.

### BACKGROUND

Micro-electromechanical systems (MEMS) are used in a variety of applications such as optical display systems. Such MEMS devices have been developed using a variety of approaches. Frequently, such MEMS devices include opposing plates. The relative separation of the two plates determines the output of the device. In one approach, a deformable deflective plate is positioned over an electrode and is electrostatically attracted to the electrode.

One approach for controlling the gap distance between electrodes is to apply a continuous control voltage to the electrodes, wherein the control voltage is increased to decrease the gap distance, and vice-versa. In such approaches the gap distance changes as charge accumulates on the electrodes, creating an electrostatic force therebetween, attracting electrodes to each other and decreasing the gap. This electrostatic force is opposed by a mechanical restoring force provided by the deflection of flexures that support one of the electrodes.

When the gap distance is reduced to a certain threshold value, usually about two-thirds of an initial gap distance, the electrostatic force of attraction between the electrodes overcomes the mechanical restoring force causing the electrodes to “snap” together or to mechanical stops. This is because at a distance less than the minimum threshold value, the capacitance is increased to a point where excess charges are drawn on the electrodes resulting in increased electrostatic attraction. This phenomenon is known as “charge runaway.”

As introduced, the electrodes are sometimes snapped to mechanical stops. This mechanical contact may result in the electrodes sticking together (or stiction). Further, this electrical contact may also result in arc welding. Accordingly, the contact may reduce the reliability and/or operating life of a device and, consequently, the display system that makes use of such a device.

### SUMMARY

A light modulator device includes a first leaf having a reflective surface formed thereon, a second leaf spaced apart from the first leaf; and a hinge, coupling the first leaf to the second leaf, the first leaf and second leaf being configured to have like charges selectively thereon to control a relative separation of said first leaf and said second leaf.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 illustrates a schematic view of a display system according to one exemplary embodiment.

FIG. 2 illustrates a schematic view of a light modulator device according to one exemplary embodiment.

FIG. 3 illustrates a light modulator device in an intermediate state according to one exemplary embodiment.

FIG. 4 illustrates a light modulator device in on state according to one exemplary embodiment.

FIG. 5 illustrates a light modulator device in a drain state according to one exemplary embodiment.

FIGS. 6-10 are schematic views showing a method of forming a light modulator device according to one exemplary embodiment.

FIG. 11 illustrates a light modulator device according to one exemplary embodiment.

FIG. 12 illustrates a light modulator device according to one exemplary embodiment.

FIG. 13 illustrates an array of light modulator devices according to one exemplary embodiment.

FIG. 14 illustrates a light modulator device according to one exemplary embodiment.

Throughout the drawings, identical reference numbers designate similar, but not necessarily identical, elements.

### DETAILED DESCRIPTION

A light modulator device is provided herein that makes use of repulsive forces to control the relative separation of opposing leaves. A plurality of devices may be combined to form a spatial light modulator for use in display systems, such as projectors, televisions, or the like. The configuration of the light modulator device described herein may provide for relatively simple, robust devices that may be adapted for various applications. An exemplary display system will first be discussed, followed by a discussion of a light modulator device and the operation of the device according to one exemplary embodiment, as well as a method of forming such a device.

In the following description, for purposes of explanation, numerous specific details are set forth in order to provide a thorough understanding of the present method and apparatus. It will be apparent, however, to one skilled in the art, that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Display System

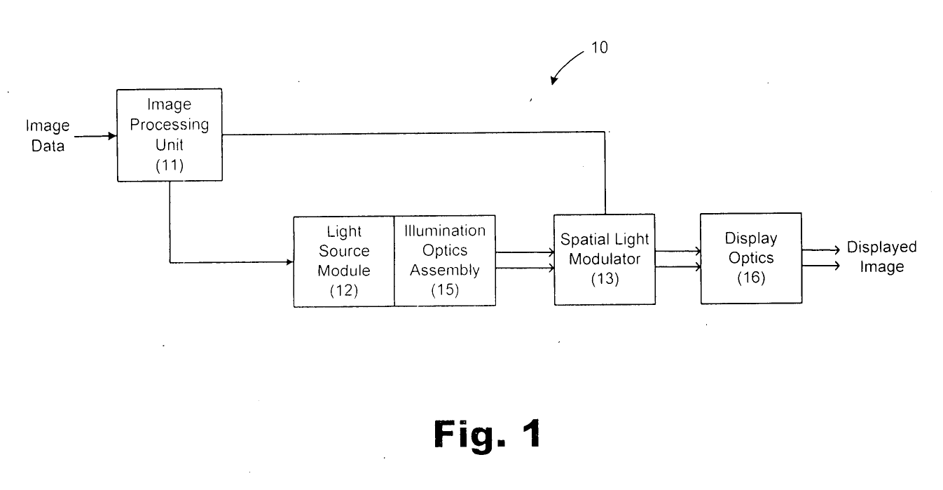

FIG. 1 illustrates a schematic view of a display system according to one exemplary embodiment. FIG. 1 illustrates an exemplary display system (10). The components of FIG. 1 are exemplary only and may be modified or changed as best serves a particular application. As shown in FIG. 1, image data is input into an image processing unit (11). The image data defines an image that is to be displayed by the display system (10). While one image is illustrated and described as being processed by the image processing unit (11), it will be understood by one skilled in the art that a plurality or series of images may be processed by the image processing unit (11). The image processing unit (11) performs various functions including controlling the illumination of a light source module (12) and controlling a spatial light modulator (SLM) (13).

The SLM (13) includes a plurality of individual light modulator devices. Several exemplary light modulator devices will be discussed below. Several of these exemplary embodiments include opposing leaves that have charges of the same polarity applied thereto. The like-charged leaves repel each other.

The angle by which the like-charged leaves are separated depends, at least in part, on the magnitude of the charges on the opposing leaves. Accordingly, the angle between the opposing leaves may be controlled by controlling the magnitude of like charges applied thereto. For ease of reference, the relative separation of the first leaf relative to the second leaf will be described with reference to an angle. Those of skill in the art will appreciate that such repulsive charges may also be used to control the gap distance between the leaves. The operation of individual light modulator devices will be discussed in more detail below. According to one exemplary embodiment, light is directed to the SLM (13) from a light source module (12).

In particular, the light source module (12) includes a lamp assembly. The light source module (12) is positioned with respect to an illumination optics assembly (15). The illumination optics assembly (15) directs light from the light source module (12) to the SLM (13).

The terms “SLM” and “modulator” will be used interchangeably herein to refer to a spatial light modulator. The incident light may be modulated in its color, phase, intensity, polarization, or direction by the modulator (13). Thus, the SLM (13) of FIG. 1 modulates the light based on input from the image processing unit (11) to form an image-bearing beam of light that is eventually displayed or cast by display optics (16) onto a viewing surface (not shown).

The display optics (16) may include any device configured to display or project an image. For example, the display optics (16) may be, but are not limited to, a lens configured to project and focus an image onto a viewing surface. The viewing surface may be, but is not limited to, a screen, television, wall, liquid crystal display (LCD), or computer monitor.

Repulse Control Reflective Light Modulator Device

FIG. 2 illustrates a schematic view of a light modulator device (200) according to one exemplary embodiment. The light modulator device (200) includes a first leaf (210) and a second leaf (220). According to one exemplary embodiment, the first leaf (210) and the second leaf (220) are electrically connected. As will be discussed in more detail below, the relative separation and positions of the first and second leaves (210, 220), and hence the operation of the light modulator device (200), is controlled by selectively establishing like charges on the first and second leaves (210, 220). As previously introduced, the relative separation and positions of the first and second leaves (210, 220) will be discussed with reference to an angle between the first and second leaves (210, 220) for ease of reference.

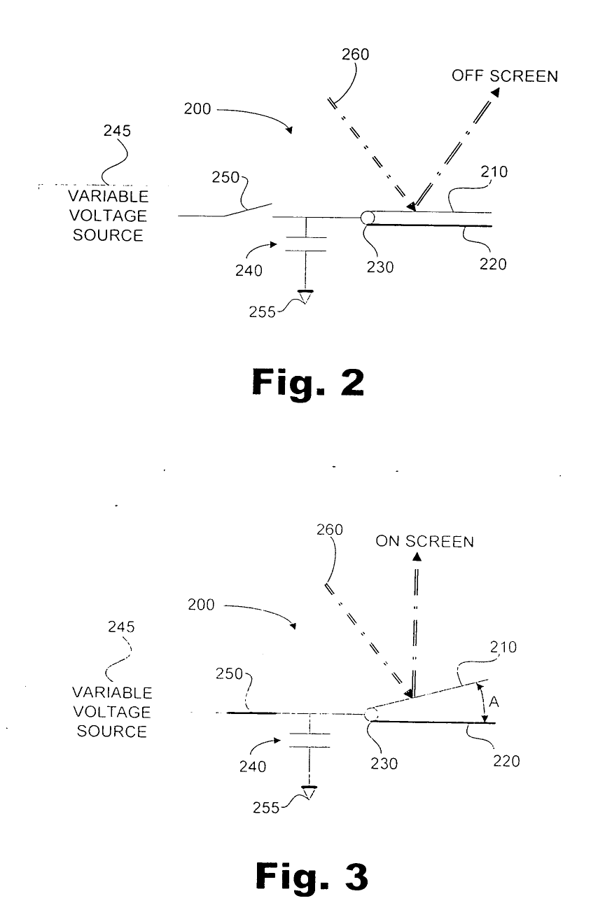

Establishing like charges on the first and second leaves (210, 220) creates a repulsive force therebetween that causes the first and second leaves (210, 220) to be repelled from one another. As the first and second leaves (210, 220) are repelled from one another, the angle A (best seen in FIG. 3) between the first and second leaves (210, 220) is enlarged. According to one exemplary embodiment, the angle A varies between about 0 degrees and approximately 90 degrees. Further, the angle A may further be varied by applying a larger repulsive force such that the angle A may be as large as approximately 180 degrees.

In particular, the first leaf (210), according to the present exemplary embodiment, rotates about a coupling member, such as a hinge (230). The hinge (230) allows relative movement between the first leaf (210) and the second leaf (220). For ease of reference, the light modulator device (200) and the first leaf (210) will be described for use in a reflective microdisplay. According to such a system, the first leaf (210) is flexible having a reflective surface formed on the top surface thereof.

The first leaf (210) is able to rotate about the hinge (230) relative to the second leaf (220). The hinge (230) shown may be a cantilever-type hinge or any other suitable hinge. Other suitable hinges may include, without limitation, door-type hinges or springs. The second leaf (220) may be formed of any suitable substance, which may include a top surface capable of having an electrostatic charge established thereon.

The light modulator device (200) is configured to be coupled to a capacitor (240) and selectively coupled to a variable voltage source (245) as controlled by the image processing unit (11; FIG. 1) via a switch (250). In particular, the image processing unit (11; FIG. 1) causes the variable voltage source (245) to generate an input signal that is sent to the light modulator device (200) while the capacitor (240) is coupled to ground (255). The input signal, according to the present exemplary embodiment, selectively controls the accumulation of like charges on each of the first leaf (210) and the second leaf (220), which may be electrically connected.

In particular, the switch (250) is configured to electrically couple the light modulator device (200) to the variable voltage source (245) such that an input signal may be directed to the light modulator device (200). The operation of the light modulator device (200) will now be discussed in more detail below.

Operation of a Repulse Control Light Modulator Device

FIG. 2 illustrates a light modulator device (200) in an initial state, according to one exemplary embodiment. According to the present exemplary embodiment, while the light modulator device (200) is not activated, the angle between the first leaf (210) and the second (220) is at a minimum value.

For example, the initial position of the first leaf (210) may be such that a light ray (260) incident on the light modulator device (200) is directed away from projection options and thus is not directed to the display surface. As a result, when little or no light is directed from the light modulator device (200) to the projection surface, a black or dark color is perceived.

The initial position thus introduced may be considered as a default state. While a black state position is described as a default state, those of skill in the art will appreciate that a fully on state or any other position may be the default position.

As seen in FIG. 2, while the light modulator is in an initial state, the switch (250) is opened such that variable voltage source (245) is decoupled from the first and second leaves (210, 220) and the capacitor (240). As a result, the amount of charge accumulated on the first leaf (210) and the second leaf (220) is minimized, such that repulsive forces between the first and second leaves (210, 220) are not repelled from another and thus will remain in their initial or default states.

FIG. 3 illustrates the light modulator device (200) in an on state according to one exemplary embodiment. In particular, the switch (250) is closed such that the variable voltage source (245) is coupled to the first and second leaves (210, 220) and the capacitor (240). Accordingly, when the switch (250) is closed, an input signal may be sent from the variable voltage source (245) to the capacitor (240).

The input signal sent according to the present exemplary embodiment establishes a charge on the capacitor (240) as well as each of the first and second leaves (210, 220). As previously introduced, the magnitude of the charge on the first and second leaves (210, 220) controls the separation between the leaves. Accordingly, as seen in FIG. 3, the angle A has been enlarged as compared to the angle shown in FIG. 2.

The angle A may be changed between two established positions that correspond to the initial state as shown in FIG. 2 and the on state as shown in FIG. 3. In such a configuration, the perceived output of the light modulator device (200) may depend, at least in part, on the frequency that the device is switched on and off and on the color of light directed thereto. For example, by switching at a faster rate, a brighter output will be perceived while switching a lower rate will cause a darker output to be perceived. The switching rate may be controlled to produce an output that varies from light to dark as desired.

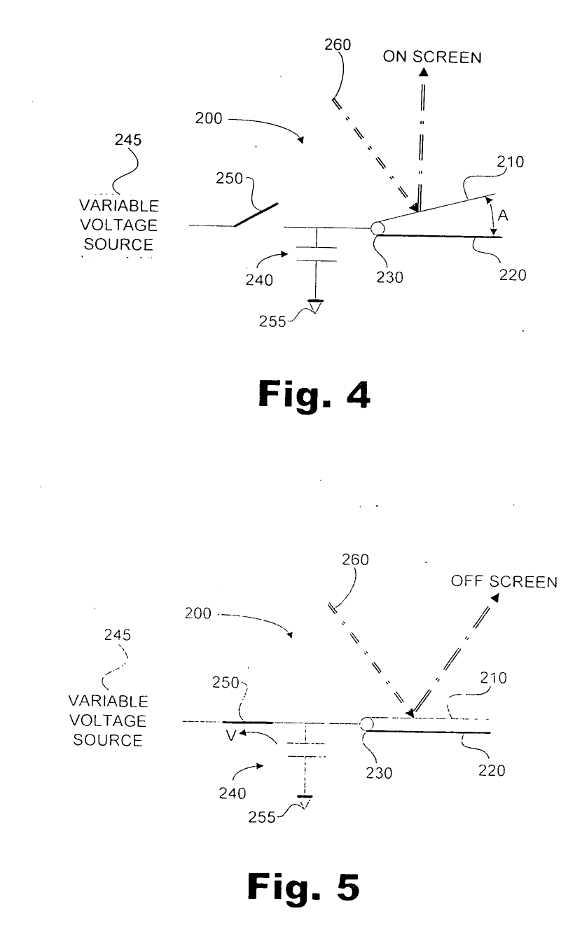

FIG. 4 illustrates the light modulator device (200) in the hold state, thereby maintaining the light modulator device (200) in an on state position while isolating the light modulator device (200), according to one exemplary embodiment. In particular, after the like charges have been established on the first and second leaves (210, 220), the switch (250) may be open relative to the variable voltage source (245). By substantially isolating the first and second leaves (210, 220) and the capacitor (240), the distance between the first and second leaves (210, 220) and thus angle A may be accurately controlled and maintained.

More specifically, once the switch (250) is opened, the charge on the capacitor (240) stabilizes the charges on the first and second leaves (210, 220). By maintaining a relatively stable charge on each of the first and second leaves (210, 220), the angle between the first and second leaves (210, 220) due to the like charges thereon may be accurately maintained. Accordingly, the performance of the light modulator device (200) may thus be accurately controlled and maintained. At some point, it may be desirable to discharge the charges accumulated on the first and second leaves (210, 220). A drain process will now be discussed in more detail.

FIG. 5 illustrates the light modulator device (200) in a drain state, according to one exemplary embodiment. As shown in FIG. 5, in the drain state, the switch (250) is closed. In such a configuration, the voltage is such that charge flows from the first and second leaves (210, 220) and the capacitor (240), as indicated by arrow V, across the switch (250), and toward the variable voltage source (245).

As the charge flows out of the light modulator device (200), the first and second leaves (210, 220) move toward their undeflected or default positions. Once a sufficient or desired amount of charge has been removed from the first and second leaves (210, 220) and the capacitor (240), the switch (250) may again be opened, as seen in FIG. 2.

Thus far, a device having low charge leakage characteristics and/or high frame rates have been discussed. Those of skill in the art will appreciate that light modulator devices (200) may also be implemented in display systems with relatively low frame rates and/or relatively high charge leakage characteristics. For example, in the case of a display system with relatively low frame rates, it may be desirable to perform intermediate refresh operations in order to maintain the angle A between the first and second leaves (210, 220) at a desired value. Further, it may be desirable to perform such a refresh operation in the case of a display system with high charge leakage characteristics. A refresh operation may include renewing an input signal or refreshing the same input signal before a drain operation is performed to maintain the angle A at a desired value.

To this point, the charges established on the light modulator device (200) have been discussed with reference to a variable voltage source (245). Those of skill in the art will appreciate that any suitable process may be used to establish like charges on the first and second leaves (210, 220). These processes may include, without limitation, the use of an electron beam or any other suitable method of selectively establishing like charges on the first and second leaf (210, 220).

Method of Forming a Light Modulator Device

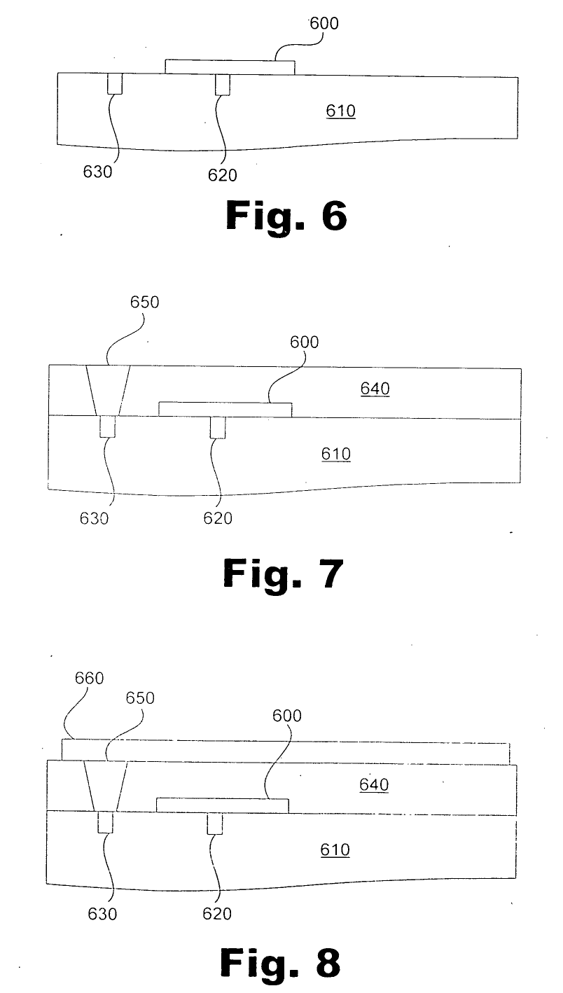

FIGS. 6 through 10 illustrate a method of forming a light modulator device (200-1; best seen in FIG. 10) according to one exemplary embodiment. As seen in FIG. 6, the process begins by forming a bottom electrode (600) on a substrate (610). The substrate (610) may have a circuit formed there, such as a CMOS/bipolar analog and/or digital circuit. First and second contacts (620, 630) extend from the circuit to the surface. The bottom electrode (600) is formed on the circuit, such that the bottom electrode (600) is in contact with the first contact (620). The bottom electrode (600) may be formed of a 0.2μ thick layer of Al or any interconnect conductor. For ease of reference, the formation of subsequent layers will be discussed with reference to a deposition/photo/etch/CMP process.

As seen in FIG. 7, a layer of dielectric (640) is formed on the bottom electrode (600). The formation of the layer of dielectric (640) includes the formation of a dielectric via (650) that extends through the layer of dielectric (640) to the contact (630), which is coupled to the circuit, as previously described. The dielectric layer may include silicon oxide, silicon nitride, silicon oxy-nitride, or any high-k material such as tantalum oxide, lithium niobate, and/or combinations thereof or any other suitable dielectric material.

FIG. 8 illustrates the next step in an exemplary process, which includes the formation of a fixed or bottom leaf (660). The bottom leaf (660) may be formed on the layer of dielectric (640). The resulting leaf may simultaneously serve as the top leaf of the capacitor (240) as well as a bottom or fixed second leaf as described above with reference to FIG. 2. The bottom leaf (660) may be formed of a thin-film conductor, such as a 0.1 μm thick layer of Al. Other suitable materials include, without limitation, other dielectric materials or metal coated dielectrics or dielectric stack mirrors.

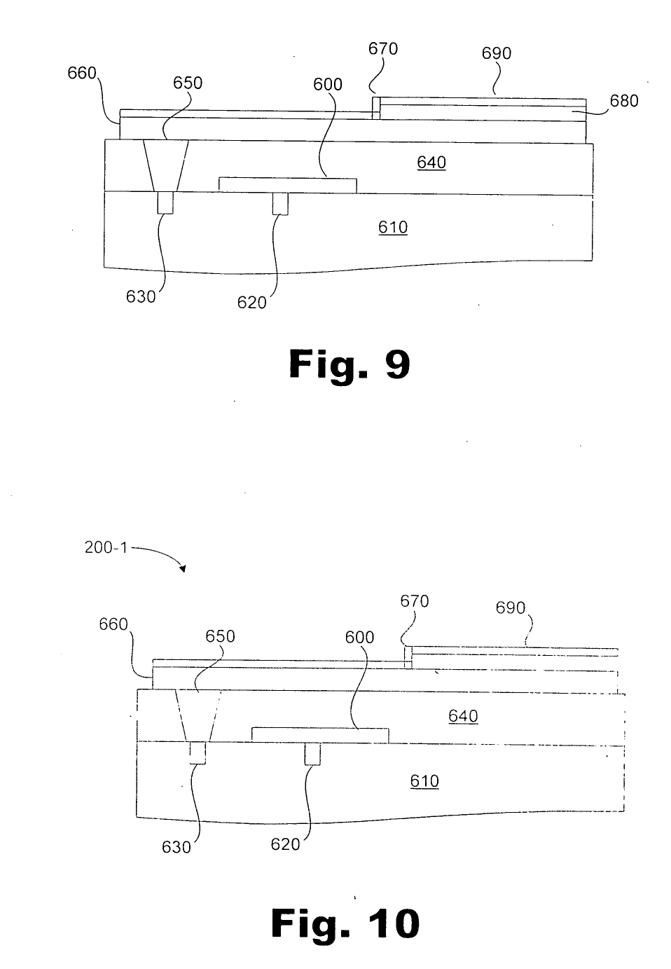

As seen in FIG. 9, after the bottom leaf (660) has been formed, a hinge (670) may be formed on the bottom leaf (660). The hinge (670) may be a cantilever-type hinge or a door-type hinge, as previously described. For example, the hinge (670) may be formed of a similar or the same material as used to form the leaves. Other suitable materials may include, without limitation silicides and other mechanically stable conductive materials.

A sacrificial layer (680) may then be formed on the bottom leaf (660). The sacrificial layer (680) may be a 0.2 thick layer of photo resist material. Thereafter, a top leaf (690) may be formed on the sacrificial layer (680). The top leaf may be formed of any suitable materials, including those used to form the bottom layer. Other sacrificial layers, such as polysilicon may also be used. As shown in FIG. 10, after the top leaf (690) has been formed, the sacrificial layer (680; FIG. 10) may be removed, thereby leaving a gap between the top leaf (690) and the bottom leaf (660).

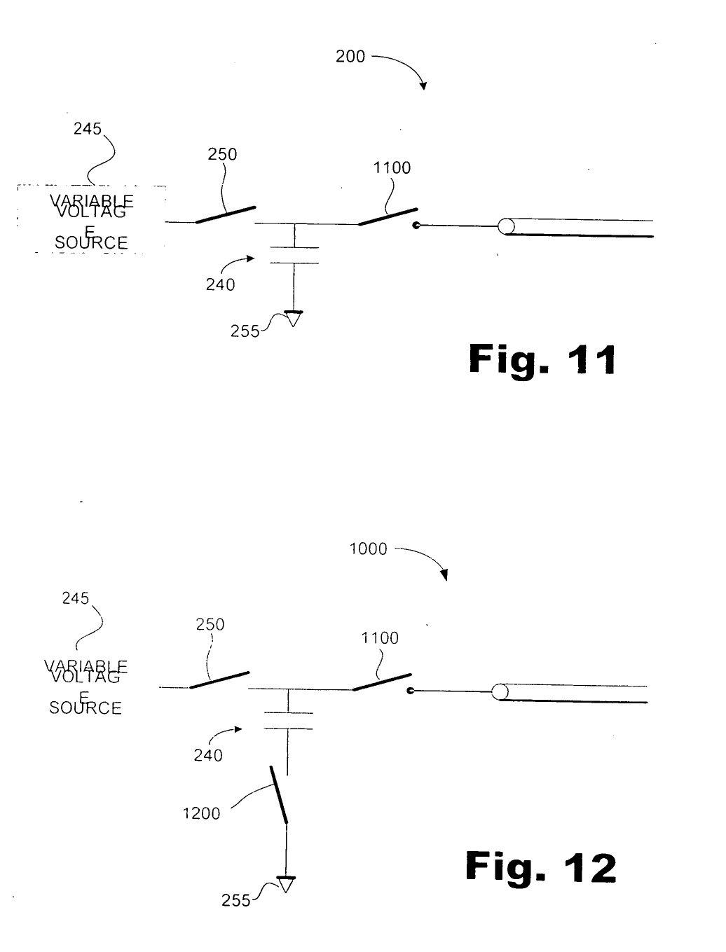

Accordingly, the present method provides for the formation of a light modulator device according to one exemplary embodiment. A light modulator device, according to the present embodiment, may then be selectively actuated by providing like charges to the top and bottom leaves (660, 690). Those of skill in the art will appreciate that the present method may be adapted to form any number of other such light modulator devices. Other such light modulator devices include, without limitation, the light modulator device (200) discussed with reference to FIG. 2 and a light modulator device having two gaps, as will be discussed with reference to FIG. 11.

Further, a single light modulator device (200) has been described as coupled to a single variable voltage source (245). In particular, multiple light modulator devices (200) may be coupled via a circuit to a single variable voltage source (245). Any number of switches may be used with the light modulator device (200).

For example, as shown in FIG. 11, an intermediate switch (1100) may be placed between the switch (250) and the light modulator device (200). In addition, as shown in FIG. 12, a ground switch (1200) may be located between the capacitor (240) and ground (255).

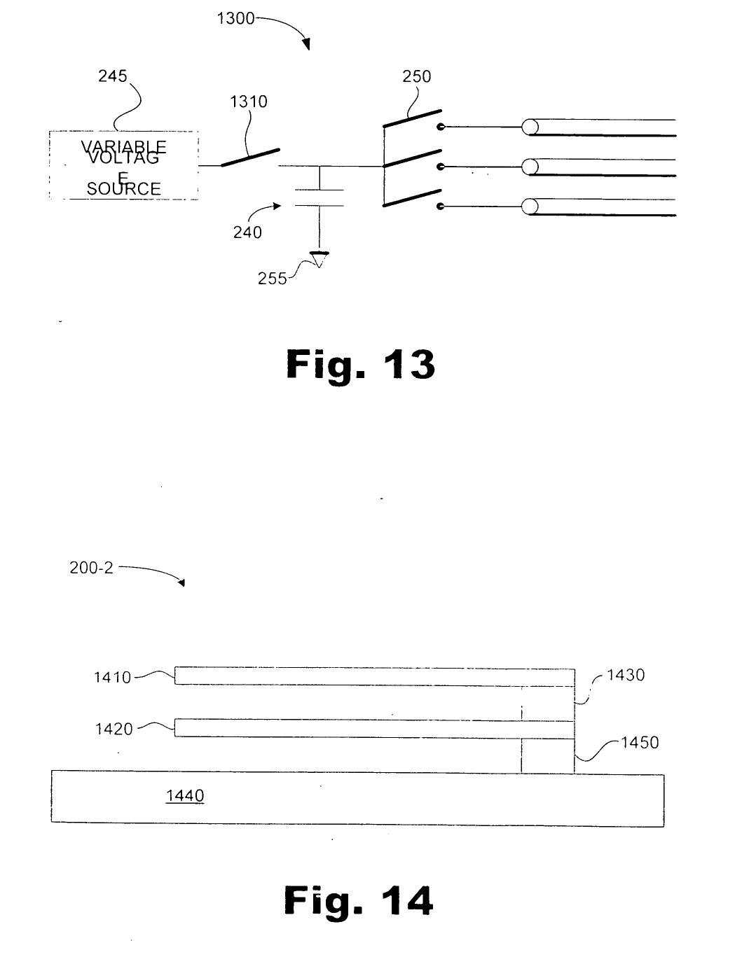

Additionally, any number of light modulator devices (200) may be controlled by any number of variable voltage sources (245). For example, FIG. 13 illustrates an array (1300) of light modulator devices (200). Each of the light modulator devices (200) may be coupled to an individual switch (250). Each individual switch (250) may in turn be coupled to a group switch (1310). The group switch (1310) may be coupled to a variable voltage source (245) while each of the individual switches (250) may be controlled independently. As a result, when the groups switch (1310) is closed to thereby couple the array (1000) to the variable voltage source (245), the selective closing of each of the individual switches (250) couples corresponding light modulator devices (200) to the variable voltage source (245), as previously discussed.

### Alternative Embodiment

FIG. 14 illustrates a light modulator device (200-2) according to one exemplary embodiment. The light modulator (200-2) includes first and second leaves (1410, 1420) coupled by a spring or hinge (1430) and separated by a gap. The second leaf (1420) is further supported above a substrate (1440) by a post (1450), such that a second gap exists between the substrate (1440) and the second leaf (1420). According to such an embodiment, the establishment of like charges on the first and second leaves (1410, 1420) cause both the first and second leaves (1410,1420) to repel from each other.

In conclusion, a light modulator device has been described herein that makes use of repulsive forces to control the relative separation and positions of opposing leaves. A plurality of devices may be combined to form a spatial light modulator for use in display systems, such as projectors, televisions, or the like. The configuration of the light modulator device described herein may provide for relatively simple, robust devices that may be adapted for various applications. An exemplary display system was discussed, followed by a discussion of a light modulator device, according to one exemplary embodiment, and the operation of the device, as well as a method of forming such a device.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

What is claimed is:

1. A light modulator device, comprising:
a first leaf having a reflective surface formed thereon;
a second leaf; and
a coupling member coupling said first leaf to said second leaf, said first leaf and second leaf being electrically connected and being configured to have like charges selectively thereon to control a relative separation of said first leaf and said second leaf.

2. The device of claim 1, wherein said second leaf is fixed relative to said first leaf.

3. The device of claim 1, wherein said first leaf and said second leaf are each configured to move relative to said coupling member.

4. The device of claim 1, and further comprising a capacitor coupled to said first leaf and said second leaf.

5. The device of claim 4, and further comprising a switch coupled to said first leaf, said second leaf, and said capacitor.

6. The device of claim 5, wherein said switch is configured to selectively couple said light modulator device to a variable voltage source.

7. The device of claim 4, wherein said second leaf comprises a leaf of said capacitor.

8. The device of claim 1, wherein said first and second leaf include at least one of dielectric material, an oxide material, or a metal.

9. The device of claim 1, wherein said coupling member comprises a cantilever-type hinge.

10. The device of claim 1, wherein said coupling member comprises a door-type hinge.

11. The device of claim 1, wherein said light modulator device comprises a reflective-type device.

12. The device of claim 11, wherein said reflective type device includes at least one of a metal mirror or dielectric stack mirror.

13. The device of claim 1, wherein said angle is between about 0 and about 180 degrees.

14. The device of claim 1, wherein said angle is between about 0 and about 90 degrees.

15. A display system, comprising:
a light source;
an image processing unit; and
at least one light modulator device including a first leaf having a reflective surface formed thereon, a second leaf, said second leaf being configured to have like charges established thereon, and a coupling member electrically coupling said first leaf to said second leaf, said image processing unit being configured to selectively establish said like charges on said first and second leaves to control a separation of said first leaf and said second leaf.

16. The display system of claim 15, and further comprising a variable voltage source coupled to said image processing unit and said light modulator device, said image processing unit being configured to control said variable voltage source to establish like charges on said first and second leaves.

17. The display system of claim 16, and further comprising at least one switch coupling said variable voltage source to said first and second leaves.

18. The display system of claim 17, wherein said switch is controlled by said image processing unit.

19. The display system of claim 15, and further comprising a plurality of switches coupled to a plurality of light modulator devices.

20. The display system of claim 19, and further comprising a capacitor coupled to said switches and said variable voltage source.

21. The display system of claim 20, and further comprising a switch between said capacitor and said variable voltage source.

22. The display system of claim 15, wherein said light modulator device comprises a reflective type device.

23. The display system of claim 15, wherein said image processing unit is configured to refresh said like charges on said first and second leaves.

24. A method of modulating light, comprising:
generating light;
directing said light to a light modulator device having first and second opposing leaves, said first and second leaves being electrically connected; and
selectively establishing like charges on said first and second opposing leaves to establish a repulsive charge therebetween to separate said first and second opposing leaves.

25. The method of claim 24, wherein said repulsive charge causes said first opposing leaf to rotate about a hinge relative to said second leaf.

26. The method of claim 24, wherein said repulsive charge causes said first and second opposing leaves each to rotate about a hinge.

27. The method of claim 24, wherein selectively establishing like charges includes providing an input signal, providing a hold signal, and providing a drain signal to said first and second leaves.

28. The method of claim 27, wherein providing an input signal, providing a hold signal, and providing a drain signal to said first and second leaves includes selectively coupling said first and second leaves to a variable voltage source.

29. The method of claim 27, and further comprising providing a refresh signal to said first and second leaves.

30. The method of claim 24, wherein selectively establishing said like charges controls separates said first and second leaves by an angle of between about 0 and about 180 degrees.

31. The method of claim 24, wherein selectively establishing said like charges controls separates said first and second leaves by an angle of between about 0 and about 90 degrees.

32. A method of forming a light modulator device, comprising:
forming a bottom leaf;
forming a coupling member;
forming a sacrificial layer on at least a portion of said bottom leaf;
forming a top leaf, and removing said sacrificial layer such that said top leaf is coupled to said bottom leaf by said coupling member and said bottom and top leaf are configured to be selectively coupled to a same charge source.

33. The method of claim 32, and further comprising forming a bottom electrode below said bottom leaf, said bottom electrode and said bottom leaf forming a capacitor.

34. The method of claim 32, wherein forming at least one of said bottom leaf and said top leaf includes forming at least one of a layer of metal, a layer or dielectric coated with metal, a thin film conductor or dielectric stack mirrors.

35. The method of claim 32, wherein forming at least one of said bottom leaf and said top leaf includes forming a 0.1 μm thick layer of aluminum.

36. A system, comprising:
means for generating light;
means for directing said light to a light modulator device; and
means for selectively establishing like charges on first and second leaves to control a separation therebetween, said first and second leaves being electrically connected.

37. The system of claim 36, and further comprising means for directing modulated light to a display surface.
